(19) United States
(12) Patent Application Publication
(10) Pub. No.: US 2011/0175740 A1
(43) Pub. Date: Jul. 21, 2011

(54) LIQUID LEVEL MONITORING SYSTEM

(75) Inventor: Todd A. Miner, Yakima, WA (US)

(73) Assignee: MINER PRODUCTS, LLC, Yakima, WA (US)

(21) Appl. No.: 13/004,479

(22) Filed: Jan. 11, 2011

Related U.S. Application Data
(60) Provisional application No. 61/297,201, filed on Jan. 21, 2010.

(51) Int. Cl. G08B 21/00; G01F 23/00

(52) U.S. Cl. 340/618; 702/55

(57) ABSTRACT

A liquid level monitoring system is configured for a wood-stemmed plant in which the stem is receivable by a reservoir configured to hold a liquid. The system includes a housing attachable to the stem of the plant. The housing may include an aperture for receiving some of the liquid in the reservoir. A circuit board is coupled to or positioned within the housing and includes a microprocessor. A sensor may be located within the housing or attached externally thereto. The sensor is operable to transmit a signal to the processor when the sensor becomes exposed primarily to air instead of the liquid in the reservoir. And, an indicator is in communication with the processor to provide at least one human perceptible signal that correlates with a liquid level in the reservoir.

### PRIORITY CLAIM

This application claims priority benefit of the filing date of U.S. Provisional Patent Application No. 61/297,201 filed on Jan. 21, 2010; the subject matter of the application is incorporated herein by reference in its entirety.

### FIELD OF THE INVENTION

This invention relates generally to a liquid level monitoring system and, more specifically, to an active liquid level monitoring system that provides human perceptible feedback.

### BACKGROUND OF THE INVENTION

Ever since the invention of tree stands, such as a Christmas tree stand, with a built-in water reservoir, a problem has existed of how to determine when additional water needs to be added to a tree stand's reservoir as water is absorbed by the tree and evaporates into the air. The normal process has required manual activity to ascertain the water level, for example, to reach under a Christmas tree to feel for water in the tree stand. This is not only inconvenient but can also be extremly uncomfortable. By maintaining a constant supply of water in a tree stand, the tree retains its moisture longer, thereby lessening the chance of premature drying and becoming a potential fire hazard.

### SUMMARY OF THE INVENTION

This invention is generally related to a liquid level detection and warning system that may advantageously detect a reduction in a water level of a reservoir configured to receive a wood-stemmed, non-rooted plant (e.g., a Christmas tree) and then emit a warning signal that enables a person to know that water should be added. By way of example, as the water level in the tree stand decreases, the detection and warning system senses when the water level is low by measuring the resistance between two electrical contacts. In one embodiment, the system senses and alerts the person after the water level has passed a number of benchmarks (e.g., levels), which in turn will provide a more accurate indiciation of how much water remains in the tree stand. In turn, the system faciliates more regular watering and allows the plant to better retain moisture, thereby lessening the chance of premature drying.

In one embodiment of the present invention, a liquid level monitoring system for a wood-stemmed plant in which the stem is receivable by a reservoir configured to hold a liquid includes a housing, a circuit board, at least one sensor and an indicator. The housing is attachable to the stem of the plant. The circuit board is positioned within the housing and includes a microprocessor. The sensor is coupled to either the housing or the circuit board and is operable to transmit a signal to the processor when the sensor becomes exposed primarily to air instead of the liquid in the reservoir. The indicator is in communication with the processor and is configured to provide at least one human perceptible signal that correlates with a liquid level in the reservoir.

In another embodiment of the present invention, a method for monitoring a liquid level in a reservoir configured to receive a wood-stemmed plant includes the steps of (1) placing a liquid level monitoring system into the reservoir, the system affixed to a stem of the plant; (2) arranging the system to bring a plurality of sensors into contact with at least some of the liquid; (3) transmitting signals to a microprocessor of the system from the plurality of sensors, the sensors arranged in a gravitational direction with each sensor operable to transmit a low-liquid signal to the microprocessor when the sensor becomes exposed primarily to air instead of the liquid in the reservoir; and (4) providing at least one human perceptible signal from the system that correlates with a level of the liquid in the reservoir.

In yet another embodiment of the present invention, a liquid level monitoring system for a wood-stemmed plant in which the stem is receivable by a reservoir configured to hold water includes a housing attachable to the stem of the plant, the housing having an aperture for receiving an amount of the water in the reservoir; an electronic circuit located within the housing; a processor located within the housing; a plurality of sensors positioned within the housing, each sensor operable to transmit a signal through the circuit to the processor if a water level of the reservoir drops below a predetermined level relative to the sensor; and a transmitter in communication with the processor, the transmitter operable to provide a signal that correlates with the water level in the reservoir.

### BRIEF DESCRIPTION OF THE DRAWINGS

The preferred and alternative embodiments of the present invention are described in detail below with reference to the following drawings.

FIG. 1 is a perspective view of a liquid level monitoring system coupled to a wooden stem according to an embodiment of the present invention;

FIG. 2 is a perspective view of the liquid level monitoring system of FIG. 1;

FIG. 3 is an exploded view of a housing for a liquid level monitoring system according to an embodiment of the present invention;

FIG. 4 is a front cut-away view of a liquid level monitoring system configured with a circuit board received within a housing according to an embodiment of the present invention;

FIG. 5 is a rear plan view of the circuit board of FIG. 4;

FIG. 6 is an exploded, perspective view of a liquid level monitoring system with a detachable tongue according to another embodiment of the present invention;

FIG. 7 is a side elevational view of the tongue of FIG. 6; and

FIG. 8 is a schematic diagram of a liquid level monitoring system with a wireless transmitter according to yet another embodiment of the present invention.

### DETAILED DESCRIPTION OF THE INVENTION

A liquid level monitoring system may advantageously detect various water levels in a reservoir and then provide an audible sound or wireless signal to warn or alert a person that the reservoir needs more water. The system may be self-contained and easily attached to the stem. The system may include multiple sensors that each provide a unique sound or signal relating to the corresponding water level in the reservoir.

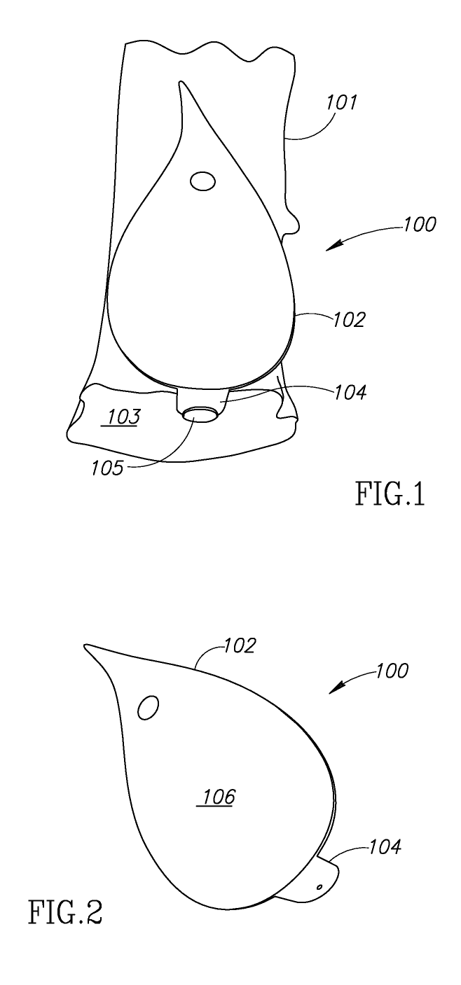

FIGS. 1 and 2 show a liquid level monitoring system 100 attached to a wood-stemmed plant (i.e., the stem) 101, which takes the form of a Christmas tree in the illustrated embodiment. The system includes a housing 102 and a tongue or flange 104 extending from the housing. In one embodiment, the tongue 104 may be tacked or otherwise fastened to a bottom surface 103 of the stem 101 using a fastening device 105. The housing 102 and the tongue are preferrably made of plastic, but may be made from other suitable materials. In the illustrated embodiment, the housing 102 includes an exterior or outer surface 106 that takes a tear-drop or rain-drop shape for aesthetic purposes. It is appreciated that the housing may take other shapes as well.

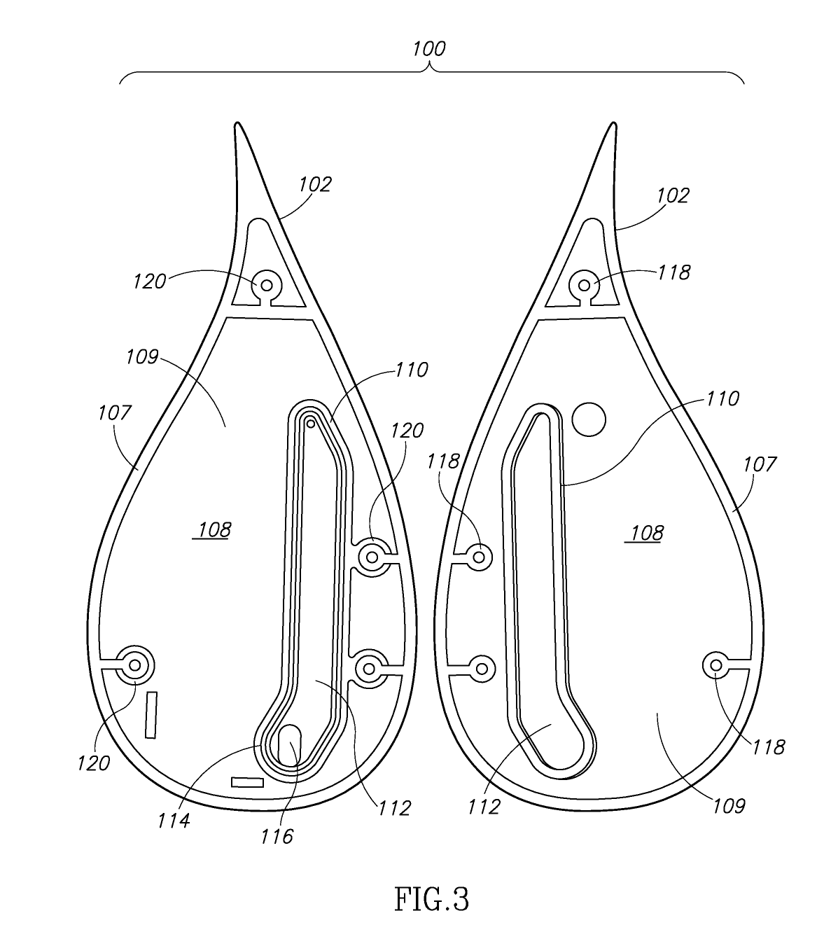

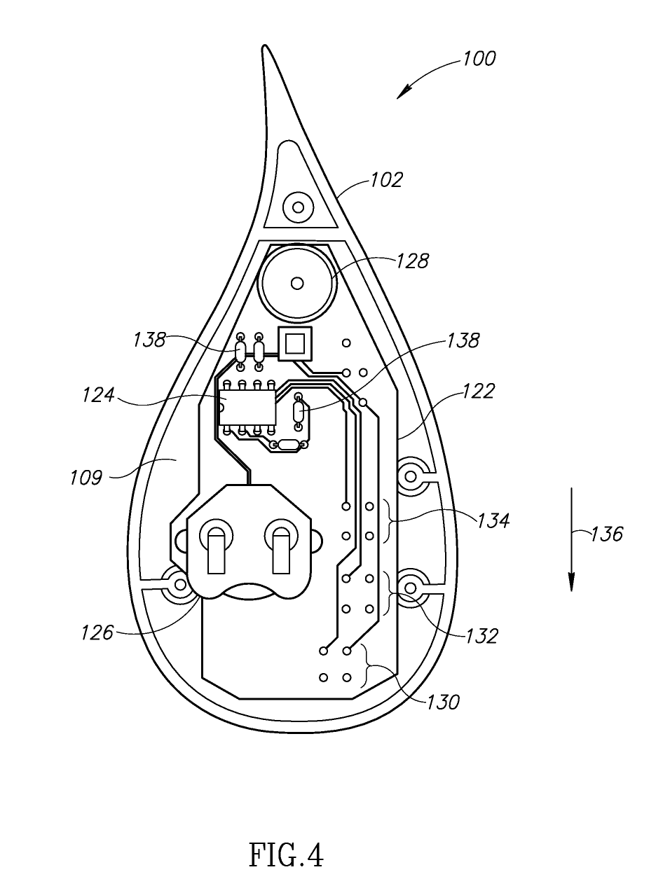

FIG. 3 shows that the housing 102 of the liquid level monitoring system 100 includes inner surfaces 108 with outer edges 107 that define a main cavity 109 and an interior wall 110 that defines a channel 112. The wall 110 may be recessed to receive a sealing member 114, which may take the form of an elastomeric gasket or a compressible sealing compound, both being sufficient to keep the liquid in the channel 112 from entering into the main cavity 109. Preferably, the housing 102 is separable into two parts as illustrated. When the two parts are coupled together, the main cavity 109 is sized to receive electrical components as described below in reference to FIG. 4. The portion of the housing 102 then forms part of the channel 112 including an aperture 116 for receiving liquid from the reservoir when the monitoring system 100 is submerged into the reservoir. The two parts of the housing 102 may be coupled together at fastening locations 118, 120, respectively. Alternatively, the two parts may be bonded, clipped, latched or otherwise coupled together.

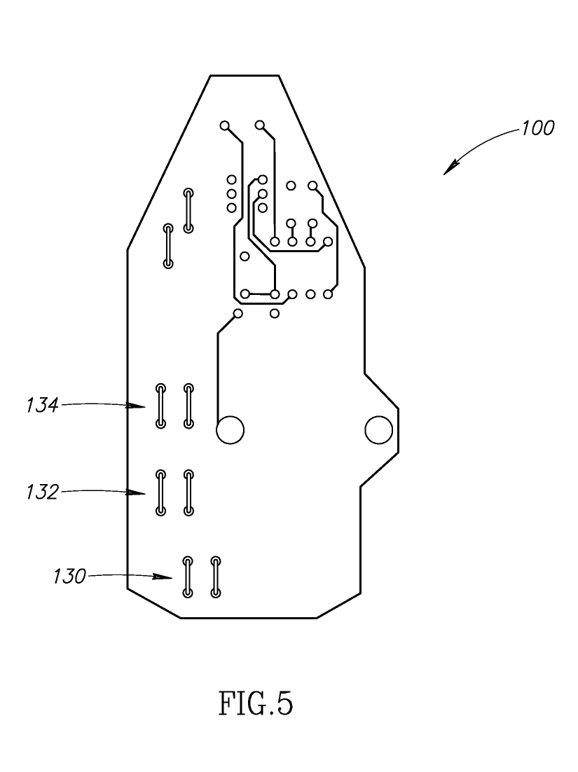

FIGS. 4 and 5 show front and back views, respectively, of a circuit board 122, which is located in the main cavity 109 of the housing 102. In the illustrated embodiment, the circuit board 122 supports a microprocessor 124, a replaceable power source 126, an indicator 128, and a plurality of sensors 130, 132 and 134 electronically coupled to the microprocessor 124 and arranged respectively along a gravitational direction 136. In addition, the circuit board 122 supports a plurality of resistors 138 electronically coupled to the microprocessor 124. The sensors 130, 132 and 134 may be metal sensors in fluid communication with the liquid that enters through the aperture 116 (FIG. 3) to fill the channel 112 (FIG. 3). The remaining components identified above remain substantially dry because they are sealed off from the channel 112 by virtue of the sealing member 114 (FIG. 3). In one embodiment, the housing 102 and wall 110 may be injection-molded as a single piece component.

In one embodiment, the sensors 130, 132 and 134 transmit respective first signals to the microprocessor 124 as the reservoir is filled and liquid initially comes into contact with the sensors. Once a liquid-contact signal has been received by the uppermost sensor 134, the microcontroller 124 commences a monitoring process. As the liquid from the reservoir is drawn up into the stem 101 (FIG. 1) through capillary action or as it evaporates into the air, the liquid level in the reservoir gradually decreases to a first predetermined liquid level in which the uppermost sensor 134 is exposed primarily to air rather than liquid. The uppermost sensor 134, as well as the other sensors, may be triggered to send a low-liquid level signal at other predetermined levels, meaning the sensor does not have to be fully exposed to air and thus out of contact with the liquid before sending the signal.

In one embodiment, the indicator 128 takes the form of a Piezo buzzer configured to emit an audible noise, which may be heard by a person in a near vicinity to the indicator 128. The power source 126 may take the form of a rechargeable, button-cell battery.

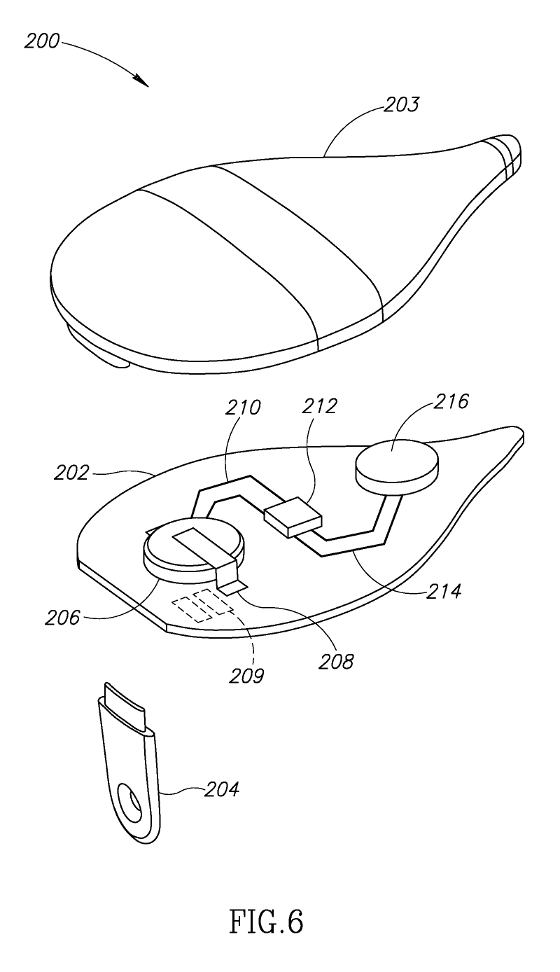

FIG. 6 shows a liquid level monitoring system 200 according to another embodiment of the present invention. The system 200 includes a circuit board 202, a housing 203 and a detachable tongue 204. A disposable battery 206 having a tab 208 is soldered onto the board 202. One or more liquid level detection sensors 209 may be coupled to a back side of the board 202 and therefore be exposed directly to the liquid during operation. Alternatively stated, the sensors 209 are external or outside of the housing 203 so that no aperture is required as compared to the previous embodiment. Similar to the above-described embodiment, the sensors 209 provide signals through conductors 210 to a processor 212, which in turn electrically communicates with a transmitter 216.

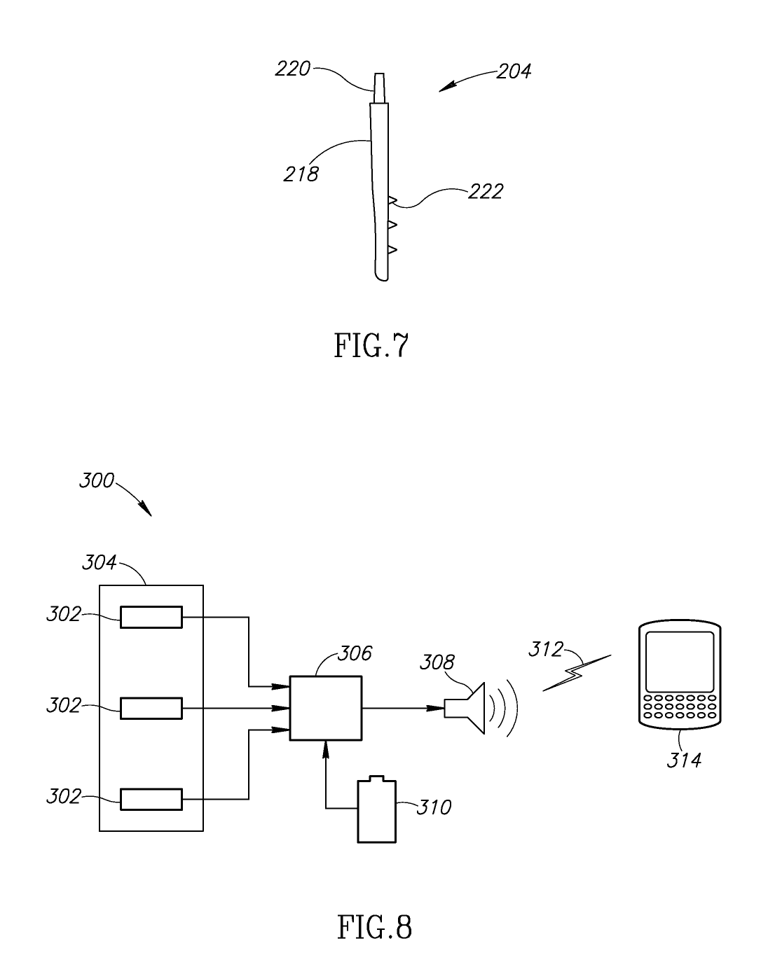

FIG. 7 shows that the tongue 204 includes a tongue body 218 coupled to an engagement portion 220. Further, the tongue 204 includes prongs 222 configured to enter a wooden stem. While the prongs 222 may not secure the system 200 to the stem, it is appreciated that they may provide positional stability for the system relative to the stem. In addition or alternatively, the tongue 204 may be coupled to the wooden stem using a fastener such as, but not limited to, a wood screw.

FIG. 8 shows a schematic diagram of a liquid level monitoring system 300 according to yet another embodiment of the present invention. Many of the components are similar to those described above and therefore will only be briefly mentioned for purposes of brevity. The system 300 includes sensors 302 located within a sealed chamber 304. The sensors 302 communicate with a processor 306, which in turn communicates with a transmitter 308. The processor 306 may be powered by a power source 310. In the illustrated diagram, the transmitter 308 takes the form of a wireless transmitter operable to send a wireless signal 312 to a computing device 314. The wireless signal 312 may be transmitted to any type of computing device such as, but not limited to, a mobile phone, a personal digital assistant (PDA), a laptop computer, a desktop computer, a network, or any other device capable of receiving the wireless signal and translating such a signal into a human perceptible output that provides notification to a person regarding the liquid level in the reservoir (e.g., the wireless signal provides the impetus for generating the human perceptible output). The notification may take the form of a text message, an email, a flashing light indicator, a vibration, a light emitting diode, etc., or some other output that is perceptible by a person as an indication of the liquid level in the reservoir.

The above-described systems may be powered ON by inserting a tack into a small hole in the back of the housing until a two-tone beep is heard, which would indicate the system is operational. Next, the system may be attached to the stem using the tongue. Alternatively, the system may be tied or otherwise attached to the stem, which is then placed into a stand (e.g., reservoir) and filled with a liquid, which may take the form of a plant nutrient mixed into water.

When the liquid level decreases by a certain amount, an audible sound emanates from the Piezo buzzer or a wireless signal is sent by the transmitter. If an audible sound is provided, the sound may periodically emanate until more liquid or water is added to the stand. If the stand is not filled and the liquid level drops further, a different audible sound or wireless signal may be provided, where the different sound or signal indicates a more urgent notification to replenish the liquid. In short, the system may include a number of sensors arranged in a gravitational direction so as the liquid level decreases each effected sensor provides a unique sound or signal.

The liquid level monitoring system may advantageously sense a plurality of water levels (e.g., two or more water levels) and then provides feedback to the user. Such feedback may take a variety of forms to enable better maintenance of the liquid level and with respect to Christmas trees may help keep the tree healthier and greener through the holiday period. In addition, the system is integrated and self-contained. In one embodiment, the liquid level monitoring system may be a single-use or seasonal device that may be disposed of when the Christmas tree, for example, is taken down. As such, it may be unnecessary to replenish or recharge the power source.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A liquid level monitoring system for a wood-stemmed plant in which the stem is receivable by a reservoir configured to hold a liquid, the system comprising:
a housing attachable to the stem of the plant;
a circuit board positioned within the housing, the circuit board having a microprocessor;
a sensor coupled to one of the housing or circuit board, the sensor operable to transmit a signal to the processor when the sensor becomes exposed primarily to air instead of the liquid in the reservoir; and
an indicator in communication with the processor, the indicator configured to provide at least one human perceptible signal that correlates with a liquid level in the reservoir.

2. The monitoring system of claim 1, wherein the plant is a Christmas tree.

3. The monitoring system of claim 1, wherein the liquid is water.

4. The monitoring system of claim 1, wherein the housing includes an extended tongue.

5. The monitoring system of claim 4, wherein the tongue is positionable adjacent a bottom surface of the stem and attachable thereto using a fastening device.

6. The monitoring system of claim 1, wherein the housing includes an aperture for receiving some of the liquid in the reservoir.

7. The monitoring system of claim 6, wherein the aperture for receiving some of the liquid in the reservoir is configured to permit water into a sealed channel formed by the housing.

8. The monitoring system of claim 7, wherein the sensor is located within the sealed channel.

9. The monitoring system of claim 7, wherein the aperture is arranged proximate a bottom portion of the sealed channel.

10. The monitoring system of claim 1, wherein the sensor is located external to the housing.

11. The monitoring system of claim 1, further comprising a removable battery coupled to the circuit board and configured to provide power to the microprocessor.

12. The monitoring system of claim 1, wherein the indicator is a buzzer that provides a first audible tone at a first frequency when the water level drops below a first threshold in the reservoir.

13. The monitoring system of claim 1, wherein the sensor is a second sensor positioned to detect a different liquid level of the reservoir.

14. A method for monitoring a liquid level in a reservoir configured to receive a wood-stemmed plant, the method comprising:
placing a liquid level monitoring system into the reservoir, the system affixed to a stem of the plant;
arranging the system to bring a plurality of sensors into contact with at least some of the liquid;
transmitting signals to a microprocessor of the system from the plurality of sensors, the sensors arranged in a gravitational direction with each sensor operable to transmit a low-liquid signal to the microprocessor when the sensor becomes exposed primarily to air instead of the liquid in the reservoir; and
providing at least one human perceptible signal from the system that correlates with a level of the liquid in the reservoir.

15. The method of claim 14, wherein placing the liquid level monitoring system into the reservoir includes tacking a tongue extending from the housing into a bottom surface of the stem.

16. The method of claim 14, wherein arranging the system to bring the plurality of sensors into contact with at least some of the liquid includes permitting the liquid to enter an aperture formed in the system.

17. The method of claim 16, further comprising submerging the aperture below a desired liquid level as to prevent the transmission of the low-liquid signal to the microprocessor.

18. The method of claim 16, wherein transmitting the signals includes measuring a resistance between two electrical contacts within the housing.

19. A liquid level monitoring system for a wood-stemmed plant in which the stem is receivable by a reservoir configured to hold water, the system comprising:
a housing attachable to the stem of the plant, the housing having an aperture for receiving an amount of the water in the reservoir;
an electronic circuit located within the housing;
a processor located within the housing;
a plurality of sensors positioned within the housing, each sensor operable to transmit a signal through the circuit to the processor if a water level of the reservoir drops below a predetermined level relative to the sensor; and
a transmitter in communication with the processor, the transmitter operable to provide a signal that correlates with the water level in the reservoir.

20. The monitoring system of claim 19, wherein the predetermined level is when the sensor becomes out of contact with the water.

21. The monitoring system of claim 19, wherein the transmitter is a wireless transmitter operable to transmit a wireless signal to a computing device.

22. The monitoring system of claim 21, wherein the computing device is a cellular phone that provides a human perceptible output based on the transmitted wireless signal.
